(19) United States
(12) Patent Application Publication
(10) Pub. No.: US 2026/0323779 A1
(43) Pub. Date: Oct. 15, 2026

(54) HEATED BASE FOR SALT TANK

(71) Applicant: TerraPower, LLC, Bellevue, WA (US)

(72) Inventor: Joshua Stuart, Renton, WA (US)

(21) Appl. No.: 19/646,478

(22) Filed: Apr. 13, 2026

Related U.S. Application Data
(60) Provisional application No. 63/789,263, filed on Apr. 15, 2025.

(51) Int. Cl. H05B 3/06; H05B 1/02; H05B 3/10

(52) U.S. Cl. CPC H05B 3/06; H05B 1/023; H05B 3/10

(57) ABSTRACT

A heated foundation system for supporting a molten salt thermal storage tank comprises a concrete ring wall, cellular glass insulation blocks disposed within the concrete ring wall, a layer of fire bricks arranged on top of the cellular glass insulation blocks, and a plurality of doped fire bricks positioned within the layer of fire bricks proximate an outer perimeter of the foundation. The doped fire bricks include a conductive coating or dopant, which enables them to generate heat via electrical resistance when an electric current is applied. A control system regulates the electric current supplied to the doped fire bricks based on temperature measurements from thermocouples, allowing for independent control of multiple heating zones within the foundation to encourage a uniform temperature profile across the tank bottom.

### BACKGROUND

Molten salt storage tanks are commonly used in industries such as concentrated solar power and nuclear energy to store high-temperature molten salts, which can be used as a heat transfer fluid or thermal energy storage medium. These tanks are typically large, flat-bottomed steel vessels designed to withstand high temperatures and corrosive environments.

Conventional molten salt storage tank designs are often based on standards borrowed from the oil and gas industry. However, the unique operating conditions and requirements of molten salt systems present additional challenges not fully addressed by these standards. For example, molten salt tanks may operate at temperatures exceeding 500°C, which can lead to significant thermal stresses and deformation if not properly managed.

One common issue with molten salt storage tanks is the development of thermal gradients across the tank floor due in part to uneven heat loss. The outer edges of the tank bottom tend to cool faster than the center, causing the tank floor to expand and contract non-uniformly. Over time, this can result in the tank bottom experiencing beyond yield stresses, leading to deformation and premature failure of the tank.

To mitigate this problem, molten salt tanks are typically installed on insulated foundations designed to minimize heat loss to the ground. One approach is to create a concrete "bucket" filled with an insulating material such as expanded clay, upon which the tank is placed. However, this method still allows for differential settling, contraction, and expansion, and does not fully address the issue of radial thermal gradients.

Therefore, there exists a need for improved molten salt tank designs that can better withstand the high-temperature operating conditions and mitigate the effects of thermal gradients on tank integrity. Solutions that can maintain a more uniform temperature profile across the tank floor while providing adequate insulation and structural support would help extend the lifespan of these critical components in molten salt thermal storage systems.

These, and other features and advantages will become apparent to those of skill in the art by reference to the following figures and description.

### SUMMARY

The present disclosure aims to address these and other limitations of prior art molten salt storage tanks by introducing a novel heated foundation system that actively counteracts thermal gradients and promotes more even temperature distribution across the tank bottom.

According to some embodiments, a heated foundation for supporting a molten salt thermal storage tank, the heated foundation includes a concrete ring wall; a layer of cellular glass insulation blocks disposed within the concrete ring wall; a layer of fire bricks arranged on top of the cellular glass insulation blocks; and a plurality of doped fire bricks positioned within the layer of fire bricks and arranged proximate an outer perimeter of the heated foundation, the doped fire bricks comprising a conductive coating configured to generate heat via electrical resistance when an electric current is applied.

In some examples, the doped fire bricks comprise a metal oxide material doped with at least one of nickel, magnesium, lithium, copper, aluminum, cerium, graphite, silicon carbide, molybdenum disilicide, and niobium. The doped fire bricks may be configured to operate at temperatures between 500°C and 1800°C.

In some instances, the doped fire bricks are arranged in a pattern extending radially inward from the outer perimeter of the heated foundation, covering the outermost 15% to 20% of the foundation radius (e.g., from about 80% to 85% of the radius to 100% of the radius). In other words, the doped fire bricks may lay in a pattern that begins at a distance of about 80% to 85% of the radius of the molten salt storage tank supported on the heated foundation, or within the outermost 20%, or 15%, or 10% of the radius of the molten salt storage tank.

In some examples, a control system is provided and configured to regulate the electric current applied to the conductive fire bricks based on temperature measurements from one or more thermocouples positioned on or near the top surface of the insulated tank foundation system. The current can be increased to increase the temperature of the conductive fire bricks through which the current flows.

The control system may be configured to define multiple independently controlled heating zones within the insulated tank foundation system. In this way, independently controlled heating zones can have different currents passing therethrough, which allows for different temperatures across each of the independent heating zones.

The plurality of doped fire bricks may be arranged in a pattern extending radially inward from the outer perimeter of the insulated foundation to a distance of about 80% to 85% of a radius of the insulated foundation, where the tank wall is 100% of radius and the center of the tank is 0% radius.

In some cases, applying the electric current to the doped fire bricks includes regulating the electric current based on temperature measurements from one or more thermocouples positioned on or near the top surface of the insulated foundation. In some cases, applying the electric current to the doped fire bricks comprises independently controlling the electric current supplied to multiple heating zones defined within the insulated foundation.

According to some embodiments, an insulated tank foundation system includes an insulated base layer configured to support a molten salt tank; a plurality of fire bricks arranged on top of the insulated base layer; and a plurality of conductive fire bricks interspersed among the plurality of fire bricks, the conductive fire bricks positioned proximate an outer perimeter of the insulated tank foundation system and extending radially inward, the conductive fire bricks comprising a conductive material configured to generate heat when an electric current is applied, thereby counteracting heat loss at the outer perimeter of the insulated tank foundation system and reducing thermal gradients across a top surface of the insulated tank foundation system.

According to some embodiments, a method for reducing thermal gradients in a molten salt tank includes the steps of providing an insulated foundation configured to support the molten salt tank; arranging a layer of fire bricks on top of the insulated foundation; positioning a plurality of doped fire bricks within the layer of fire bricks proximate an outer perimeter of the insulated foundation, the doped fire bricks configured to be electrically conductive; applying an electric current to the doped fire bricks to generate heat via electrical resistance; measuring a temperature of a bottom of the molten salt tank at a first location and a second location; determining that the temperature at the first location is less than the temperature at the second location; and increasing an electrical current to the doped fire bricks associated with the first location.

According to some embodiments, a heated foundation for supporting a molten salt thermal storage tank, includes a concrete ring wall; a layer of cellular glass insulation blocks disposed within the concrete ring wall; a layer of fire bricks arranged on top of the cellular glass insulation blocks; and a plurality of doped fire bricks positioned within the layer of fire bricks and arranged into separate controllable heating zones, the doped fire bricks configured to generate heat via electrical resistance when an electric current is applied.

In some embodiments, the method further includes preheating the molten salt tank prior to filling with molten salt by applying electrical current to the electrically conductive fire bricks. In some cases, during idle periods of the molten salt tank, the electrical current is maintained to the electrically conductive fire bricks to prevent solidification of salt within the tank.

In some embodiments, the insulated tank foundation system further comprises a slip plate disposed above the electrically conductive fire bricks, the slip plate configured to accommodate differential thermal expansion between a molten salt tank supported on the system and the insulated base layer.

In some examples, the doped fire bricks comprise a metal oxide material doped with at least one of nickel, magnesium, lithium, copper, aluminum, cerium, graphite, and niobium. In some cases, each separate controllable zone comprises independently regulated electrical current to provide distinct heating zones. The heating zones may be defined by insulative material separating regions of doped fire bricks, and the insulative material may be fire bricks, such as bricks that are not electrically conductive.

A control system may be configured to adjust electrical current in each heating zone based on temperature feedback from thermocouples positioned near a top surface of the foundation. In some cases, the control system utilizes a plurality of electrode layers to apply differentiated electrical currents to each heating zone.

According to some embodiments, an insulated tank foundation system includes an insulated base layer; a plurality of fire bricks arranged on top of the insulated base layer; a plurality of electrically conductive fire bricks interspersed among the plurality of fire bricks and arranged into a plurality of heating zones, each heating zone being electrically isolated from adjacent heating zones; a first electrode layer disposed on a first side of the electrically conductive fire bricks and a second electrode layer disposed on a second side of the electrically conductive fire bricks opposite the first side, each of the first and second electrode layers comprising a plurality of individually addressable electrode sections corresponding to the heating zones; and a control system configured to independently regulate an electric current delivered through each heating zone via the individually addressable electrode sections.

In some instances, the doped fire bricks are configured to operate at temperatures between 500°C and 1800°C, and in some cases, between 500°C and 800°C.

According to some embodiments, an insulated tank foundation system includes an insulated base layer configured to support a molten salt tank; a plurality of fire bricks arranged on top of the insulated base layer; and a plurality of conductive fire bricks interspersed among the plurality of fire bricks, the conductive fire bricks arranged into independently controllable heating zones, each zone comprising a conductive material configured to generate heat when an electric current is applied.

According to some embodiments, a method for reducing thermal gradients in a foundation supporting a molten salt tank includes the steps of providing an insulated foundation configured to support the molten salt tank, the insulated foundation comprising a concrete ring wall filled with cellular glass insulation blocks; arranging a layer of fire bricks on top of the cellular glass insulation blocks; positioning a plurality of doped fire bricks within the layer of fire bricks to form separate controllable zonal regions; and applying an electric current to the doped fire bricks in each zone independently to generate heat via electrical resistance.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

The following drawing figures, which form a part of this application, are illustrative of described technology and are not meant to limit the scope of the technology as claimed in any manner, which scope shall be based on the claims appended hereto.

FIG. 1 illustrates a schematic view of a storage tank on a foundation having multiple layers, in accordance with some embodiments.

FIG. 2 illustrates a graph showing floor heat flux of a tank, in accordance with some embodiments.

FIG. 3 illustrates an elevation view of a heated foundation for a storage tank, in accordance with some embodiments.

FIG. 4 illustrates a portion of a heated foundation, having electrode layers, in accordance with some embodiments.

FIG. 5 illustrates an arrangement of a heated foundation with heating zones, in accordance with some embodiments.

FIG. 6 illustrates a process flow for providing a heated foundation for a storage tank, in accordance with some embodiments.

### DETAILED DESCRIPTION

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

Embodiments described herein relate to an electrically heated foundation system for supporting high-temperature molten salt storage tanks and similar vessels. The foundation incorporates advanced refractory bricks with conductive coatings strategically arranged to provide a uniform heating profile across the tank bottom. This active heating system counteracts heat losses and minimizes thermal stresses, thereby improving tank durability and reliability.

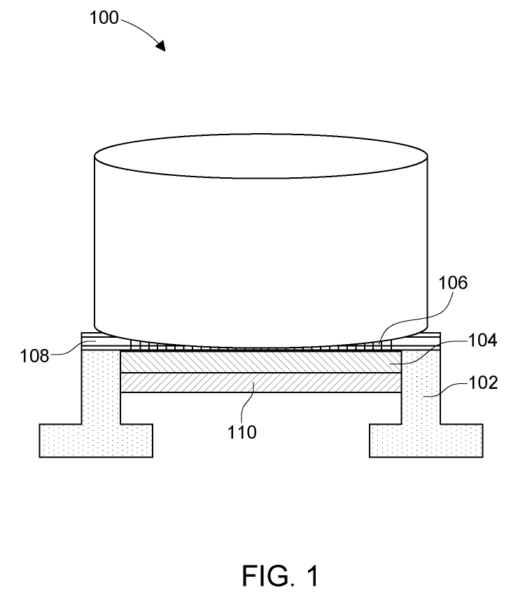

FIG. 1 illustrates a schematic view of a tank foundation system 100 for supporting a tank thereon. The foundation system 100 may include a concrete ring wall 102, cellular glass insulation blocks 104, a layer of refractory bricks 106 (e.g., fire bricks, or insulating fire bricks), and a plurality of electrically conductive bricks 108 embedded within the refractory brick layer. The electrically conductive bricks 108 may form a layer by themselves, or may be interspersed among one or more refractory bricks 106 and electrically connected together to form an electrical current path from one electrically conductive brick to the next. The concrete ring wall 102 provides mechanical support for the foundation and helps contain the insulating glass blocks 104. The cellular glass insulation blocks 104, made from materials such as foamed borosilicate glass, provide excellent thermal insulation while also having sufficient compressive strength to support the weight of the storage tank and may be formed as bricks, or may be loose material held in place by the surrounding structure, such as the bricks. In some cases, the refractory brick layer 106 rests on top of the cellular glass insulation and presents a stable, high-temperature resistant, and insulating surface for the tank bottom.

In some cases, a concrete ring wall 102 is used as part of the foundation. However, other types of foundational structures may also be used, such as, for example, a slab on grade, an elevated pile cap, or some other suitable foundation structure. For efficiency in describing embodiments herein, a ring wall will be used as an exemplary concrete foundation and it should be appreciated that the embodiments should not be so limited, unless otherwise specified. The ring wall 102 serves multiple functions, including providing mechanical support for the tank, containing the insulating materials, and anchoring the tank to the ground. The design and construction of the ring wall preferably accounts for the unique loads and environmental conditions associated with these high-temperature applications.

The ring wall 102 is typically constructed using reinforced concrete, a composite material consisting of a cement-based matrix reinforced with steel bars, mesh, fibers, or a combination. The concrete mix is designed to provide high compressive strength, durability, and resistance to thermal stresses. The specific mix proportions, including the type and amount of cement, aggregate, water, and additives, are carefully selected based on the anticipated loads and exposure conditions.

The completed ring wall 102 provides a robust, stable foundation for the storage tank. The concrete's high compressive strength allows it to support the weight of the tank and its contents, which can be substantial for large-scale molten salt systems. The ring shape and continuity of the wall also help to distribute loads evenly and resist overturning moments.

In addition to its structural functions, the ring wall 102 also serves as a barrier to contain the insulating materials supporting the tank. In some embodiments, one or more layers of cellular glass insulation 104, such as cellular glass insulation blocks, are used to support and insulate the sides and/or bottom of the tank. The ring wall 102 helps to keep these blocks in place and prevent them from shifting or settling over time.

The ring wall 102 may also help anchor the tank to the foundation and preventing lateral movement. This is typically achieved through the use of anchor bolts or other mechanical fasteners that connect the tank base to the top of the ring wall. The anchors are designed and installed to withstand the thermal expansions and contractions of the tank during operation.

In some cases, the ring wall 102 is formed with flexible joints and/or reinforced corners, such as to enhance its ability to accommodate any differential settlements or movements of the soil without cracking or losing its structural integrity.

The ring wall 102 is also designed to withstand the thermal stresses induced by the high-temperature tank and its contents. For example, some embodiments may utilize thermal breaks or expansion joints to mitigate thermal stresses.

Cellular glass insulation blocks 104 offer an effective insulating material in the foundation system 100 for high-temperature molten salt storage tanks and other thermal applications. These blocks are made from specially formulated glass that is typically heated and expanded to create a lightweight, porous structure with excellent thermal and mechanical properties. The use of cellular glass insulation blocks 104 may help to minimize heat losses from the tank while also providing structural support for the refractory brick lining.

The high porosity of cellular glass blocks gives it excellent thermal insulation properties. The small, enclosed pores limit the transmission of heat by conduction, convection, and radiation.

In addition to its low thermal conductivity, cellular glass insulation also has a high thermal resistance due to its low density and high specific heat capacity. The specific heat of cellular glass insulation is around 840 J/kg·K, which means it can absorb and store a significant amount of thermal energy without undergoing a large temperature change. This thermal inertia helps to stabilize the temperature of the foundation and reduce fluctuations during transient heating or cooling events.

Despite its low density and high porosity, cellular glass insulation also possesses good mechanical strength and rigidity. In some cases, the compressive strength of cellular glass insulation blocks ranges from 0.7-1.6 MPa, depending on the density and formulation. This is sufficient to support the weight of the refractory brick lining and the molten salt tank under normal operating conditions.

One of the advantages of cellular glass insulation blocks over other insulating materials is their excellent dimensional stability and resistance to degradation. Unlike organic insulation materials, cellular glass insulation is completely inorganic and does not degrade or off-gas at high temperatures. It also has a very low coefficient of thermal expansion (8-9 × 10⁻⁶ K⁻¹), which allows it to maintain its shape and size even under large temperature gradients.

Cellular glass insulation blocks are also highly resistant to water absorption and moisture damage. The closed-cell structure of the foam prevents the ingress of liquid water, while the hydrophobic nature of the glass surface resists the adsorption of water vapor. This makes cellular glass insulation a suitable insulating material for use in damp or humid environments, such as those found in some molten salt storage applications.

In some cases, the cellular glass insulation blocks are used to insulate the bottom and/or sides of the molten salt tank. The blocks are typically arranged in a staggered pattern, with the joints between blocks offset to minimize thermal bridging. The blocks are laid on a particulate bed 110, such as sand or gravel, to allow for differential movement and prevent point loading.

The thickness of the cellular glass insulation layer is determined based on the desired insulation level and the temperature gradient across the foundation. In some cases, a cellular glass insulation block layer may be on the order of 12”, 15”, 18”, 24”, 30”, 36” or more. Depending on the thickness of the individual blocks, this may result in 2, 3, 4, 6, 8 10, 12 or more layers cellular glass insulation blocks.

In addition to their thermal and mechanical properties, cellular glass insulation blocks also offer environmental and safety benefits. The use of recycled glass as a raw material helps to reduce waste and conserve natural resources. The inorganic, non-combustible nature of cellular glass insulation also makes it a safe and fire-resistant insulation option for high-temperature applications.

The foundation system 100 may include other layers as well, for example, a particulate bed layer 110, such as crushed gravel, crushed concrete, sand, chip stone, calcium silicate, ceramic particles, or other suitable material may be provided as a first layer in contact with the ground and to support the cellular glass insulation 104 layer. In addition, an optional layer of sand may be provided, such as in between the brick layers 106, 108, and the tank bottom to provide additional support and insulation to the tank bottom.

The electrically conductive bricks 108 are active components of the heating system. These bricks may be composed of a refractory filler material, a dopant, a coating, or a combination. For example, a filler material may include one or more of magnesium oxide or alumina, combined with conductive particles like graphite flakes, silicon carbide, or metal powders. The conductive particles may be oriented during the brick pressing process to enhance electrical conductivity and thermal conductivity. In some cases, the electrically conductive bricks 108 are doped metal oxide firebricks. As used herein, doping a material is the process of intentionally adding a small amount of a foreign substance into a material to change its properties. For example, a fire brick may be doped with an electrically conductive material to create heterogenous regions in the material that allow electrical conductivity and to provide a conductive circuit. As used herein, a “conductive circuit” refers to an electrically conductive pathway formed within or on the doped fire bricks, including conductive coatings, doped regions, or interconnected conductive particles, that enables electrical current to flow through the brick and generate heat via electrical resistance. Some suitable combinations of electrically conductive dopants may include, without limitations, Chromium Oxide (Cr₂O₃) doped with Nickel (Ni) or Magnesium (Mg); Nickel Oxide (NiO) doped with Lithium (Li) or Copper (Cu); Zinc Oxide (ZnO) doped with Aluminum (Al); Zirconium Oxide (ZrO₂) doped with Cerium (Ce); and Titanium Oxide (TiO₂) doped with Niobium (Nb) to name a few. The doped metal oxides may be integrated into the brick material to achieve the desired electrical conductivity and resistance heating properties.

In some cases, to enhance the thermal insulation properties of the conductive bricks without compromising electrical performance, the bricks may include a plurality of non-continuous passages. These passages may be arranged perpendicular to the predominant orientation of the conductive particles. In some cases, the passages may not extend fully through the brick in order to maintain structural integrity.

In some embodiments, the electrically conductive bricks 108 are strategically positioned within the refractory brick layer to concentrate heating near the perimeter of the tank where heat losses are greatest. In some embodiments, the conductive bricks are arranged in concentric rings extending radially inward to approximately 80-85% of the foundation radius. Electrical contacts are made to the conductive bricks and connected to a power supply and control system.

During operation, the control system regulates electrical power to the conductive bricks 108 to maintain a desired temperature profile across the tank bottom. The control system may receive feedback from a plurality of thermocouples embedded at various locations within the brick layer, or in contact with the tank bottom, or a combination. Based on the thermocouple readings, the control system adjusts the voltage and/or current supplied to the conductive bricks 108 in different zones.

Heat transfer from the electrically heated bricks to the tank bottom occurs primarily by conduction and radiation. The electrically conductive bricks 108 provide excellent thermal conductivity, promoting an even temperature distribution across the top surface of the brick layer. The tank bottom, typically made of steel, may rest directly on the bricks, may rest on a layer of sand positioned between the bricks and the tank bottom, or may rest on a bearing plate that conveys the heat generated by the bricks to the tank bottom and provides additional structural support by spreading the load of the tank across the foundation. Radiative heat transfer may also contribute to thermal transfer, particularly near the tank perimeter where the temperature gradient is steepest.

The concrete ring wall 102 and cellular glass insulation 104 also experience some heating due to their proximity to the high-temperature components. However, the thermal conductivity of these materials is much lower than that of the steel tank and refractory bricks and may be separated by a further layer of insulation, such as a layer of mineral wool.

One potential concern with the electrically heated foundation is the risk of overheating or hotspot formation. To mitigate this risk, the control system continuously monitors the temperature profile and adjusts power input accordingly. If an area begins to overheat, the control system can selectively reduce power to the affected zone. In extreme cases, the system can be shut down automatically to prevent damage.

In addition to the thermal benefits, the electrically heated foundation also offers advantages in terms of tank construction and maintenance. The active heating system allows for more rapid and controlled preheating of the tank during commissioning. This can reduce thermal shock and minimize the risk of damage during the initial filling with molten salt. The heated foundation also helps to prevent solidification of the salt during extended idle periods, reducing the need for expensive remelting operations. The control system may be configured to preheat the tank bottom to a target temperature prior to the introduction of molten salt, the target temperature being selected to reduce thermal shock during filling.

The electrically heated foundation systems described herein represent a significant advancement in the design of high-temperature molten salt storage tanks. By incorporating electrically conductive refractory bricks, the foundation provides active, targeted heating to counteract heat losses and minimize thermal stresses. The strategic arrangement of conductive and insulating components, combined with a sophisticated control system, ensures greater control of temperature gradients and energy efficiency.

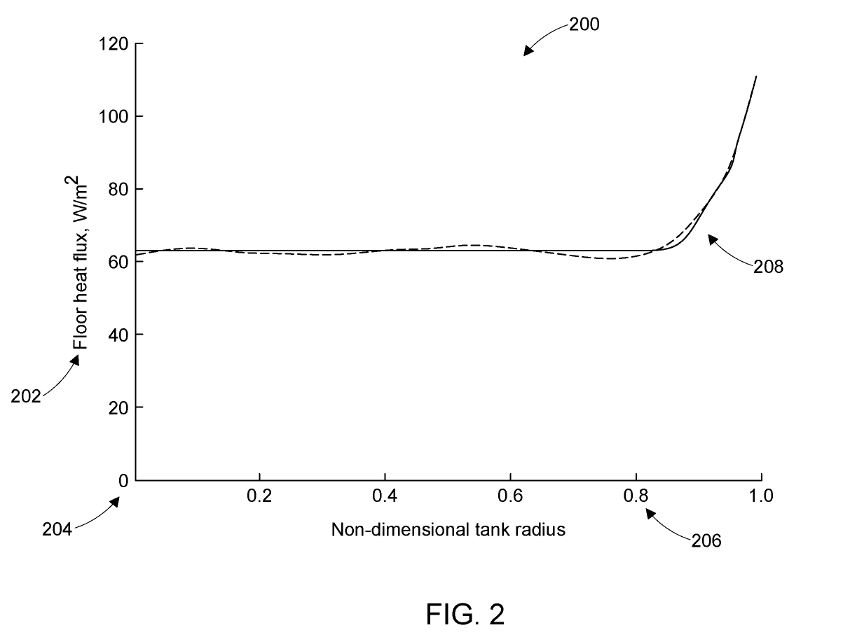

FIG. 2 illustrates a graph 200 showing the tank floor heat flux (in W/m²) along the radius of the molten salt storage tank. As used herein, heat flux describes the rate of heat transfer per unit area. In the context of a molten salt storage tank, floor heat flux is a measure of the thermal energy that flows through the floor of the tank due to temperature differences between the molten salt and the surrounding environment.

The heat flux in a molten salt storage tank is governed by three primary mechanisms: conduction, convection, and radiation. Conduction refers to the transfer of heat through direct contact between materials, such as the transfer of heat from the molten salt to the tank walls. Convection involves the transfer of heat by the movement of fluids, such as the circulation of molten salt within the tank or the flow of air around the exterior of the tank. Radiation is the transfer of heat through electromagnetic waves, which can occur between the molten salt and the tank surfaces or between the tank and the surrounding environment.

In a typical molten salt storage tank, the heat flux is highest at the walls and floor of the tank, where the temperature difference between the molten salt and the surrounding environment is greatest. The heat flux through the walls and floor is primarily driven by conduction, as the molten salt is in direct contact with these surfaces. The magnitude of the heat flux depends on several factors, including the thermal conductivity of the tank materials, the thickness of the walls and floor, and the temperature gradient across these components.

As shown in the graph, the floor heat flux 202 remains very constant from the center of the tank 204 (0% radius), outward to about 80% of the radius of the tank 206. However, beyond 80% of the radius of the tank, it can be seen that the floor heat flux 202 turns sharply upward 208, which indicates that the heat losses nearer the edges of the tank are significantly higher than the heat losses near the center of the tank 204. Consequently, in some embodiments, the electrically conductive bricks are concentrated underneath the periphery of the tank, such as within an area that is greater than 80% of the radius of the tank. Of course, it should be apparent that, depending on the tank design, the foundation design, the environmental factors, and other factors, that some of the electrically conductive bricks may be located nearer the center of the tank than 80%.

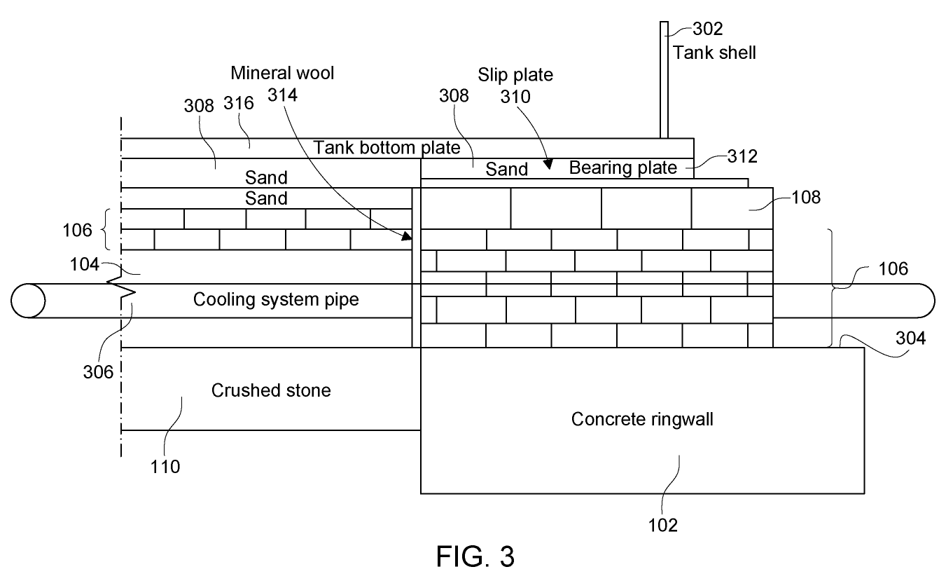

FIG. 3 illustrates a schematic representation of the heated foundation, in accordance with some embodiments. A concrete ring wall 102 may be formed as an outer perimeter support, and may define a ring that is sized to support the vertical walls of the storage tank 302. That is, the ring wall 102 may define an upper horizontal surface 304 that is underneath the tank sidewall 302. In an interior portion of the ring wall 102, a particulate layer 110, such as crushed stone, may sit on compacted earth and provide a base layer. On top of the particulate layer, a layer of glass insulation block, such as a cellular glass insulation block 104 may be provided as discussed in relation to other embodiments. The cellular glass insulation 104 may include one or more conduits, such as a cooling system pipe 306 that provides a cooling system to maintain the foundation at a suitable temperature, and to draw away heat from the lower layers of the foundation.

Above the cellular glass insulation 104 layer may be one or more layers of insulating firebrick 106. The insulating firebrick 106 provides an insulation layer to help maintain the temperature of the storage tank and to minimize heat losses and thermal gradients from the storage tank. In some cases, a layer of sand 308 may be located on top of the insulating firebrick 106 layer to provide a support bed for the storage tank.

In some embodiments, the ring wall 102 supports one or more layers of insulating firebrick 106 to minimize heat losses from the storage tank downward to the ground. The insulating brick layers 106 may support one or more layers of electrically conductive bricks 108 that can be used to heat the tank. In some cases, the electrically conductive bricks 108 are disposed nearer the periphery of the storage tank and may provide additional heat near the perimeter of the tank, where heat losses are greatest and may thus maintain a more even temperature gradient across the tank bottom than if the electrically conductive bricks were not part of the foundation.

In some cases, a slip plate 310 may be placed on the electrically conductive firebrick 108 layer, such as to allow differential thermal movement between the storage tank and the foundation. Optionally, a layer of sand 308 may be placed on top of the slip plate 310. A bearing plate 312 may be located underneath the tank shell to provide additional support of the tank and to disperse the weight of the tank across the foundation.

In some examples, an insulation layer 314 is provided between the layer of electrically conductive bricks 108 and the refractory bricks 106. The insulation layer may be any suitable type of insulation, and in some cases, is mineral wool. The tank may have a bottom plate 316, which may be the tank bottom, that sits on the foundation and is supported thereby.

To minimize heat losses and maintain the desired temperature of the molten salt, the storage tank is typically designed with insulation layers and heat management systems. The walls and floor of the tank may be lined with refractory materials, such as ceramic bricks or castable refractories, which have low thermal conductivity and can withstand high temperatures. These refractory linings help to reduce the heat flux through the walls and floor by providing a thermal barrier between the molten salt and the outer shell of the tank.

In addition to refractory linings, molten salt storage tanks may also incorporate external insulation layers, such as mineral wool, calcium silicate, or perlite, to further reduce heat losses. These insulation materials are applied to the exterior of the tank and help to minimize the heat flux through the walls and roof by reducing the temperature gradient between the tank surface and the ambient environment.

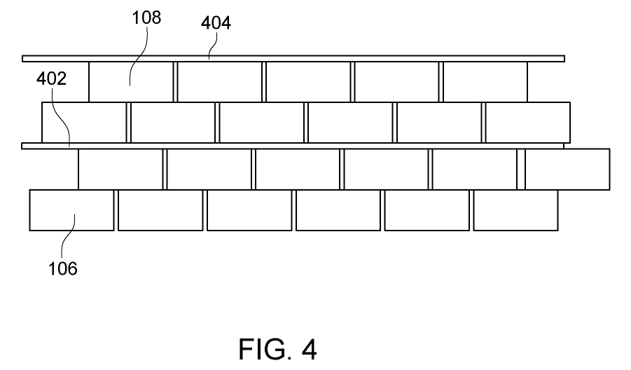

FIG. 4 illustrates a portion of a heated foundation, having electrode layers, in accordance with some embodiments. According to some embodiments, a layer of refractory bricks 106 may be disposed below the electrically conductive bricks 108. It should be understood that the electrically conductive bricks 108 may sit on any suitable sub-layer and may not be disposed above refractory bricks. The electrically conductive bricks 108 may be provided as a single layer, as two layers, as three layers, or more layers. In some cases, a first electrode layer 402 may be provided below the electrically conduct brick layers 108. A second electrode layer 404 may be provided above the electrically conductive brick layers 108. Thus, the electrical current may flow from the first electrode layer 402, through the electrically conductive brick layers 108 and to the second electrode layer 404.

In some examples, the first and/or second electrode layers 402, 404 are electrically conductive bricks that may be specially tailored to have a low electrical resistance. For instance, the electrode layers 402, 404 may be highly doped bricks and provide low heat generation.

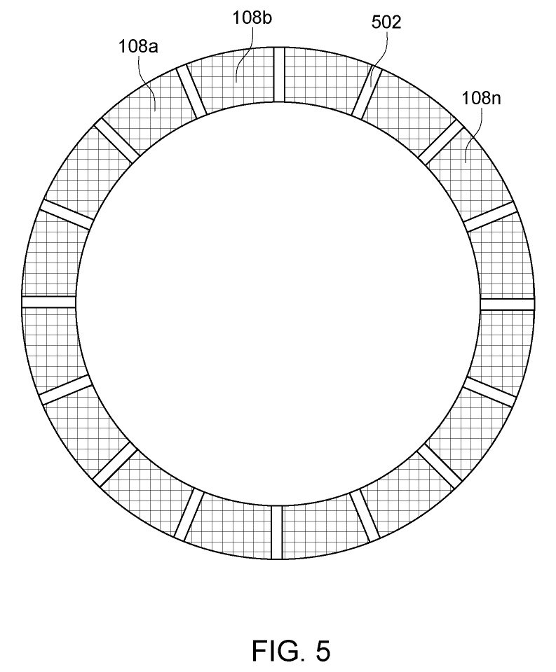

FIG. 5 illustrates a layer of electrically conductive bricks having different zones, in accordance with some embodiments. A layer of electrically conductive bricks 108a, may be electrically separated by an insulator 502. The insulator may be any suitable insulator 502, and in some cases, is insulative refractory bricks. That is, bricks that are not electrically conductive can be placed within the layer of electrically conductive bricks to create different zones that are not in electrical communication with one another. As shown, a first zone is created by bricks 108a, a second zone by bricks 108b, to 108n. Each of these zones may be insulated from adjacent zones by an insulator 502. Similarly, an electrode layer may be provided that aligns with the zones such that each zone may be electrically driven independently. For example, while all the zones may have electrical current supplied to provide a heated base for a molten salt storage tank, one side of the tank may experience more rapid heat loss than another side. For instance, where the wind is blowing onto the tank, the wind impinging on a windward side of the tank may cause a greater heat loss to that side of the tank compared with the opposing leeward side of the tank where the wind does not directly impinge. Accordingly, one or more zones of the electrically conductive bricks 108a may be supplied with a higher electrical current to result in a higher foundation temperature to counter the heat loss from the tank due to weather conditions. In some cases, a control system is configured to monitor the temperature of each of the zones and control an electrical current supplied to each of the zones in order to maintain a desired temperature profile along the radial direction of the tank.

While FIG. 5 is described as showing a layer of electrically conductive bricks 108a, it should be appreciated that an electrode layer could appear substantially similar to the layer of electrically conductive bricks in that the electrode layer could have portions that are electrically insulated such that each section of the electrode layer can be individually addressed by an electrical current so that each section of the electrode layer may have a unique voltage and/or current that is transmitted through the section of electrode, through a section of the electrically conductive bricks, and to another electrode.

In some cases, a first electrode layer includes a plurality of individually addressable sections wherein each individually addressable section corresponds with a section of an electrically conductive brick layer. A second electrode layer may be in electrical communication with each of the sections of the electrically conductive brick layer, and the second electrode may have individually addressable sections that correspond with the sections of the first electrode. In use, a first current may be passed through a first section of the first electrode, which then passes through a first section of the electrically conductive brick layer, and to a first section of the second electrode. Similarly, a second current may be passed through a second section of the first electrode, which then passes through a second section of the electrically conductive brick layer, and to a second section of the second electrode. The first current and the second current may be different which results in different temperatures of the first section of the electrically conductive brick and the second section of the electrically conductive brick.

The current provided to the first electrode may be any suitable current and any suitable voltage, and may include single phase power, three phase power, or otherwise.

The result is that each section of the electrically conductive brick layer may be electrically driven to achieve a desired temperature. The sections of the electrically conductive brick layer may be controlled to reduce temperature gradients across the bottom of the molten salt tank both in a radial direction, and around the circumference of the tank. By reducing the temperature gradients, the tank will experience a more uniform thermal expansion and contraction, which reduces thermal stresses, settling, and premature failure of the tank.

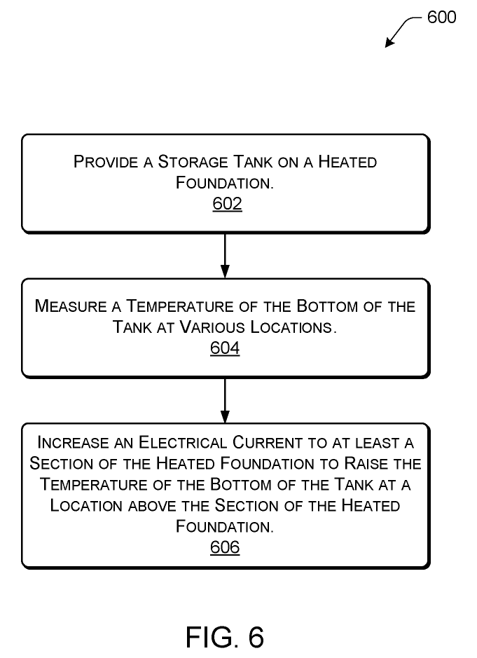

FIG. 6 illustrates a process flow 600 for providing and controlling a heated foundation for a storage tank, in accordance with some embodiments. At block 602, a storage tank is provided on a heated foundation. The storage tank may be any suitable storage tank storing a liquid having a temperature above ambient. In some cases, the liquid may be provided as a solid and through heating goes through a phase change, such as from solid to liquid. In some cases, the heated foundation for the storage tank provides thermal energy to raise the temperature of the liquid in the storage tank.

At block 604, the temperature of the bottom of the storage tank is measured at various locations around the bottom of the storage tank. This may be done through any suitable manner and any suitable equipment. In some cases, thermocouples may be provided inside the tank, outside the tank, or a combination. While the liquid inside the tank may be actively mixed in order to homogenize the temperature of the liquid, the temperature of the tank may be different across the radius of the tank and also at different locations around the periphery of the tank. Temperature measuring sensors may be located around the outside of the tank near the bottom of the tank, and also underneath the tank, to measure the temperature of the tank at various locations.

At block 606, an electrical current may be provided, or increased, to at least a section of the heated foundation to provide resistance heating to that section of the foundation. In some cases, an electrical current may be provided to each section of the heated foundation, and the current at the individual sections of the foundation may be adjusted individually to reduce temperature gradients across the bottom of the tank. In some cases, the control system is configured to compare temperature readings from multiple locations and, responsive to determining that a temperature at a first location is lower than a temperature at a second location, increase the electrical current supplied to the electrically conductive fire bricks proximate the first location to reduce the temperature difference between the first location and the second location.

In some embodiments, the control system continuously monitors temperatures at a plurality of locations across the bottom of the molten salt tank and dynamically adjusts the electrical current supplied to the electrically conductive fire bricks to maintain a substantially uniform temperature profile across the bottom of the tank.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of.” Finally, for ease of use, the terms “including” and “having” (and their derivatives), are to be construed as being inclusive and open-ended, i.e., synonymous with “including, but not limited to.”

The specification and annexed drawings disclose examples of systems, apparatus, devices, and techniques that may provide control and optimization of a heated base that alleviates thermal gradients on a tank storing heating fluids. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The methods described in relation to embodiments herein may be implemented by one or more processors executing instructions that cause the processors to carry out the disclosed methods.

Throughout the instant specification, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A heated foundation for supporting a molten salt thermal storage tank, the heated foundation comprising:
a concrete ring wall;
a layer of cellular glass insulation blocks disposed within the concrete ring wall;
a layer of fire bricks arranged on top of the cellular glass insulation blocks; and
a plurality of doped fire bricks positioned within the layer of fire bricks and arranged proximate an outer perimeter of the heated foundation, the doped fire bricks comprising a conductive circuit configured to generate heat via electrical resistance when an electric current is applied.

2. The heated foundation of claim 1, wherein the doped fire bricks comprise a metal oxide material doped with one or more of nickel, magnesium, lithium, copper, aluminum, cerium, graphite, silicon carbide, molybdenum disilicide, and niobium.

3. The heated foundation of claim 1, wherein the doped fire bricks are configured to operate at temperatures between 500°C and 1800°C.

4. The heated foundation of claim 1, wherein the doped fire bricks are arranged in a pattern extending radially inward from the outer perimeter of the heated foundation a distance of 15% to 20% of a radius of the heated foundation.

5. The heated foundation of claim 1, wherein the doped fire bricks comprise a refractory material impregnated with at least one of silicon carbide, molybdenum disilicide, or graphite.

6. The heated foundation of claim 1, further comprising a control system configured to regulate the electric current applied to the doped fire bricks based on temperature measurements from one or more thermocouples positioned on or near a top surface of the heated foundation.

7. The heated foundation of claim 1, wherein the control system is configured to define multiple independently controlled heating zones within the heated foundation, each heating zone comprising a subset of the doped fire bricks that is electrically isolated from adjacent heating zones by insulative material.

8. The heated foundation of claim 1, further comprising a bearing plate disposed above the doped fire bricks and configured to distribute a load of the molten salt thermal storage tank across the heated foundation.

9. A method for reducing thermal gradients in a molten salt tank, the method comprising:
supporting the molten salt tank on an insulated foundation, the insulated foundation comprising a plurality of electrically conductive fire bricks positioned proximate an outer perimeter of the insulated foundation;
measuring a temperature at a first location and a second location on or near a bottom of the molten salt tank;
determining that the temperature at the first location is lower than the temperature at the second location; and
responsive to the determining, increasing an electrical current supplied to a subset of the electrically conductive fire bricks proximate the first location to reduce a temperature difference between the first location and the second location.

10. The method of claim 9, wherein the insulated foundation comprises a concrete ring wall, cellular glass insulation blocks disposed within the concrete ring wall, and a layer of fire bricks arranged on top of the cellular glass insulation blocks, wherein the electrically conductive fire bricks are positioned within the layer of fire bricks.

11. The method of claim 9, wherein the electrically conductive fire bricks are arranged into a plurality of independently controllable heating zones, and wherein increasing the electrical current comprises selectively increasing the electrical current to a heating zone proximate the first location without increasing the electrical current to a heating zone proximate the second location.

12. The method of claim 9, further comprising continuously monitoring temperatures at a plurality of locations across the bottom of the molten salt tank and dynamically adjusting the electrical current supplied to the electrically conductive fire bricks to maintain a substantially uniform temperature profile across the bottom of the molten salt tank.

13. The method of claim 9, further comprising, prior to filling the molten salt tank with molten salt, preheating the molten salt tank by applying the electrical current to the electrically conductive fire bricks to raise a temperature of the bottom of the molten salt tank to a target temperature.

14. The method of claim 9, further comprising, during an idle period of the molten salt tank, maintaining the electrical current to the electrically conductive fire bricks to prevent solidification of salt within the molten salt tank.

15. The method of claim 9, wherein the electrically conductive fire bricks are arranged in a pattern extending radially inward from the outer perimeter of the insulated foundation, covering an outermost 15% to 20% of a radius of the insulated foundation.

16. An insulated tank foundation system comprising:
an insulated base layer;
a plurality of fire bricks arranged on top of the insulated base layer;
a plurality of electrically conductive fire bricks interspersed among the plurality of fire bricks and arranged into a plurality of heating zones, each heating zone being electrically isolated from adjacent heating zones;
a first electrode layer disposed on a first side of the electrically conductive fire bricks and a second electrode layer disposed on a second side of the electrically conductive fire bricks opposite the first side, each of the first electrode layer and the second electrode layer comprising a plurality of individually addressable electrode sections, each individually addressable electrode section corresponding to one of the plurality of heating zones; and
a control system configured to independently regulate an electric current delivered through each heating zone via the individually addressable electrode sections.

17. The insulated tank foundation system of claim 16, wherein each heating zone is electrically isolated from adjacent heating zones by insulative fire bricks positioned between regions of the electrically conductive fire bricks.

18. The insulated tank foundation system of claim 16, wherein the electrically conductive fire bricks are positioned proximate an outer perimeter of the insulated tank foundation system and extend radially inward, covering an outermost 15% to 20% of a radius of the insulated tank foundation system.

19. The insulated tank foundation system of claim 16, wherein the control system is configured to adjust the electric current in each heating zone based on temperature feedback from a plurality of thermocouples positioned near a top surface of the insulated tank foundation system.

20. The insulated tank foundation system of claim 16, further comprising a slip plate disposed above the electrically conductive fire bricks, the slip plate configured to accommodate differential thermal expansion between a molten salt tank supported on the insulated tank foundation system and the insulated base layer.
